(19) United States
(12) Patent Application Publication
(10) Pub. No.: US 2017/0343375 A1
(43) Pub. Date: Nov. 30, 2017

(54) SYSTEMS TO DYNAMICALLY GUIDE A USER TO AN AUTONOMOUS-DRIVING VEHICLE PICK-UP LOCATION BY AUGMENTED-REALITY WALKING DIRECTIONS

(71) Applicant: GM Global Technology Operations LLC, Detroit, MI (US)

(72) Inventors: Gila Kamhi, ZICHRON YAAKOV (IL); Asaf Degani, TEL AVIV (IL)

(21) Appl. No.: 15/606,410

(22) Filed: May 26, 2017

Related U.S. Application Data
(60) Provisional application No. 62/343,376, filed on May 31, 2016.

(51) Int. Cl. G01C 21/36; G06T 11/60; G01C 21/34

(52) U.S. Cl. CPC G01C 21/3647; G01C 21/3407; G06T 11/60

(57) ABSTRACT

A system, implemented at a mobile or portable user device having a display to present augmented-reality walking directions from a present user location to an autonomous-vehicle pickup location. The system includes an augmented-reality walking-directions module that, when executed, dynamically generates or obtains walking-direction artifacts for presentation, by a portable user device display, with real-time camera images to show a recommended walking path from the present user location toward the autonomous-vehicle pickup location, yielding real-time augmented-reality walking directions changing as the user moves with a portable user device. The system also includes an augmented-reality directions-presentation module that, when executed, initiates displaying the real-time augmented-reality walking directions from the present user location toward the vehicle pickup location. The system may also include or be in communication with an autonomous-vehicle-service application to allow the user to reserve an autonomous-vehicle ride, to be met by the user at the pickup location.

### TECHNICAL FIELD

The present disclosure relates generally to autonomous vehicles and, more particularly, to systems and methods for pairing autonomous shared vehicles or taxis with users using augmented reality to provide user directions.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

With highly automated vehicles expected to be commonplace in the near future, a market for fully-autonomous taxi services and shared vehicles is developing.

While availability of autonomous-driving-capable vehicles is on the rise, users' familiarity with autonomous-driving functions, and comfort and efficiency in finding an autonomous shared or taxi vehicle that they are to meet for pickup, will not necessarily keep pace. User comfort with the automation and meeting routine are important aspects in overall technology adoption and user experience.

### SUMMARY

In one aspect, the technology relates to a system, implemented at a mobile or portable user device having a display to present augmented-reality walking directions from a present user location to an autonomous-vehicle pickup location. The hardware-based processing unit, and a non-transitory computer-readable storage component.

The storage component in various embodiments includes an augmented-reality walking-directions module that, when executed by the hardware-based processing unit, dynamically generates or obtains walking-direction artifacts for presentation, by a portable user device display, with real-time camera images to show a recommended walking path from the present user location toward the autonomous-vehicle pickup location, yielding real-time augmented-reality walking directions changing as the user moves with a portable user device.

The storage component in various embodiments also includes an augmented-reality directions-presentation module that, when executed by the hardware-based processing unit, initiates displaying the real-time augmented-reality walking directions from the present user location toward the autonomous-vehicle pickup location.

In various embodiments, the non-transitory computer-readable storage component comprises an autonomous-vehicle-service application configured to allow the user to reserve an autonomous-vehicle ride, to be met by the user at the autonomous-vehicle pickup location. And the augmented-reality walking-directions module and the augmented-reality directions-presentation module are part of the autonomous-vehicle-service application.

The system in various embodiments includes the display in communication with the hardware-based processing unit to, in operation of the system, present said real-time augmented-reality walking directions from the present user location toward the autonomous-vehicle pickup location.

The system in various embodiments includes the camera in communication with the hardware-based processing unit to, in operation of the system, generate said real-time camera images.

The autonomous-vehicle pickup location may differ from a present autonomous-vehicle location, and the walking-direction artifacts in various embodiments includes (i) a first vehicle-indicating artifact positioned dynamically with the camera image to show the present autonomous-vehicle location, and (ii) a second vehicle-indicating artifact positioned dynamically with the camera image to show the autonomous-vehicle pickup location.

In various embodiments, at least one of the first vehicle-indicating artifact or the second vehicle-indicating artifact is configured, and arranged with the real-time camera images, to indicate that the present autonomous-vehicle pickup location or the autonomous-vehicle pickup location is behind a structure or object visible in the camera images.

In various embodiments, the walking-direction artifacts comprise a vehicle-indicating artifact positioned dynamically with the camera image to show the autonomous-vehicle pickup location.

In various embodiments, the artifacts include a vehicle-indicating artifact positioned dynamically with the camera image to show the autonomous-vehicle pickup location; and the vehicle-indicating artifact is configured, and arranged with the real-time camera images, to indicate that the autonomous-vehicle pickup location is behind a structure or object visible in the camera images.

In another aspect, the present technology relates to a portable system for implementation at a user mobile-communication device to provide amended-reality-walking directions to an autonomous-vehicle pickup location. The system includes a hardware-based processing unit and a non-transitory computer-readable storage component comprising various modules for performing functions of the present technology at the mobile-communication device.

The modules are in various embodiments part of an application at the portable device, such as an augmented-reality walking-directions (ARWD) application, an autonomous vehicle reservation application, or an ARWD extension to such a reservation application.

The modules include a mobile-device-location module that, when executed by the hardware-based processing unit, determines a geographic mobile-device location.

The modules also include an environment-imaging module that, when executed by the hardware-based processing unit, receives, from a mobile-device camera, real-time image data corresponding to an environment in which the mobile communication device is located.

The modules further include an augmented-reality-walking directions module that, when executed by the hardware-based processing unit, presents together, by way of a mobile-device display component, a real-time image rendering of the image data showing the environment and virtual artifacts indicating walking directions from the geographic mobile-device location to the autonomous-vehicle pickup location.

In various embodiments, the system includes the mobile-device camera and/or the mobile-device display component mentioned.

The pickup location may differ from a present autonomous-vehicle location, and the artifacts in that case can also include a virtual vehicle positioned in a manner corresponding to the present autonomous-vehicle location. The virtual pickup location and the virtual vehicle can both be shown by a vehicle, which may look similar, but are shown in differing manners to indicate that one is the autonomous pickup location and one is the present autonomous vehicle location.

In various embodiments, the augmented-reality-walking directions module, when executed by the hardware-based processing unit, generates the walking directions based on the geographic mobile-device location and data indicating the autonomous-vehicle pickup location.

The virtual artifacts in embodiments include a virtual vehicle positioned dynamically in the real-time image rendering in a manner corresponding to the autonomous-vehicle pickup location.

The augmented-reality-walking directions module, in presenting the real-time image rendering of the image data showing the environment and virtual artifacts indicating walking directions from the geographic mobile-device location to the autonomous-vehicle pickup location, may presents the virtual vehicle as being behind an object in the environment.

The virtual artifacts include a path connecting the mobile-device location to the autonomous-vehicle pickup location, such as a virtual line or virtual footprints showing the user a direction to walk to reach the autonomous-vehicle pickup location.

In another aspect, the present technology relates to the non-transitory computer-readable storage component referenced above.

In still another aspect, the technology relates to algorithms for performing the functions or processes including the functions performed by the structure mentioned herein.

In yet other aspects, the technology relates to corresponding systems, algorithms, or processes of or performed by corresponding apparatus, such as for the autonomous vehicle, which may send vehicle location and possibly also an ARWD instruction or update to the mobile-communication device, or a remote server, which may send the same to the portable device.

Other aspects of the present technology will be in part apparent and in part pointed out hereinafter.

### DESCRIPTION OF THE DRAWINGS

FIG. 1 illustrates schematically an example vehicle of transportation, with local and remote computing devices, according to embodiments of the present technology.

FIG. 2 illustrates schematically more details of the example vehicle computer of FIG. 1 in communication with the local and remote computing devices.

FIG. 3 illustrates schematically components of an example personal or add-on computing device being, by way of example, mobile phone, a driver wearable in the form of smart eyewear, and a tablet.

FIG. 4 shows example algorithm and processes for performing various functions of the present technology.

FIG. 5 shows an example augmented-reality walking-directions display, as shown on the display of a portable user device.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

The present disclosure describes, by various embodiments, systems and methods for pairing an autonomous shared or taxi vehicle with a customer, and guide the user, or customer, to a pick-up zone or location using augmented reality.

Augmented-reality directions can be determined dynamically based on any of various factors including user location, vehicle location, traffic, estimated time of arrival or planned pick-up time, planned route, location and itinerary of other users.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trains, trolleys, the like, and other.

While select examples of the present technology describe autonomous vehicles, the technology is not limited to use in autonomous vehicles, or to times in which an autonomous-capable vehicle is being driven autonomously. It is contemplated for instance that the technology can be used on connection with human-driven vehicles, though autonomous-driving vehicles are focused on herein.

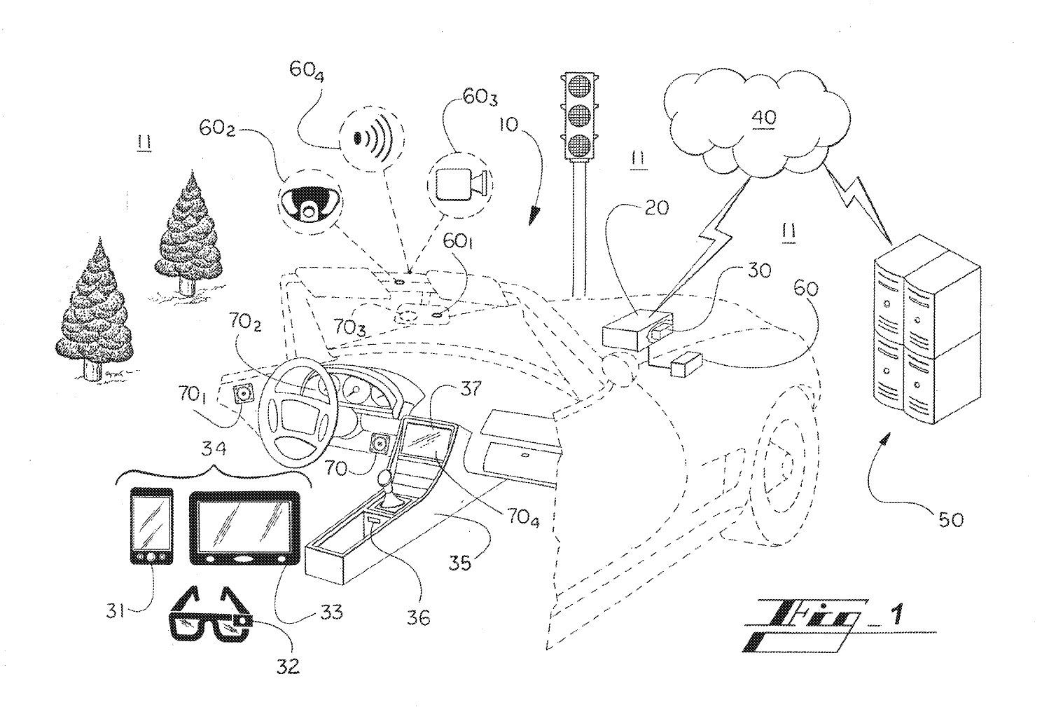

### II. Host Vehicle—FIG. 1

Turning now to the figures and more particularly the first figure, FIG. 1 shows an example host structure or apparatus 10 in the form of a vehicle.

The vehicle 10 is in most embodiments an autonomous-driving capable vehicle, and can meet the user at a vehicle pick-up location, and drive the user away, with no persons in the vehicle prior to the user's entrance, or at least with no driver.

The vehicle 10 includes a hardware-based controller or controller system 20. The hardware-based controller system 20 includes a communication sub-system 30 for communicating with mobile or portable user devices 34 and/or external networks 40.

While the portable user device 34 are shown within the vehicle 10 in FIG. 1 for clarity of illustration, the portable user device 34 will not be in the vehicle 10 in operation of the portable user device, according to the present technology, if the vehicle 10 is the target vehicle, because the portable user device 34 will be guiding the user to the vehicle 10 by augmented-reality walking direction to a pickup location for the autonomous vehicle 10.

By the external networks 40, such as the Internet, a local-area, cellular, or satellite network, vehicle-to-vehicle, pedestrian-to-vehicle or other infrastructure communications, etc., the vehicle 10 can reach mobile or local systems 34 or remote systems 50, such as remote servers.

Example portable user devices 34 include a user smartphone 31, a first example user wearable device 32 in the form of smart eye glasses, and a tablet. Other example wearables 32, 33 include a smart watch, smart apparel, such as a shirt or belt, an accessory such as arm strap, or smart jewelry, such as earrings, necklaces, and lanyards.

The vehicle 10 has various mounting structures 35 including a central console, a dashboard, and an instrument panel. The mounting structure 35 includes a plug-in port 36—a USB port, for instance—and a visual display 37, such as a touch-sensitive, input/output, human-machine interface (HMI).

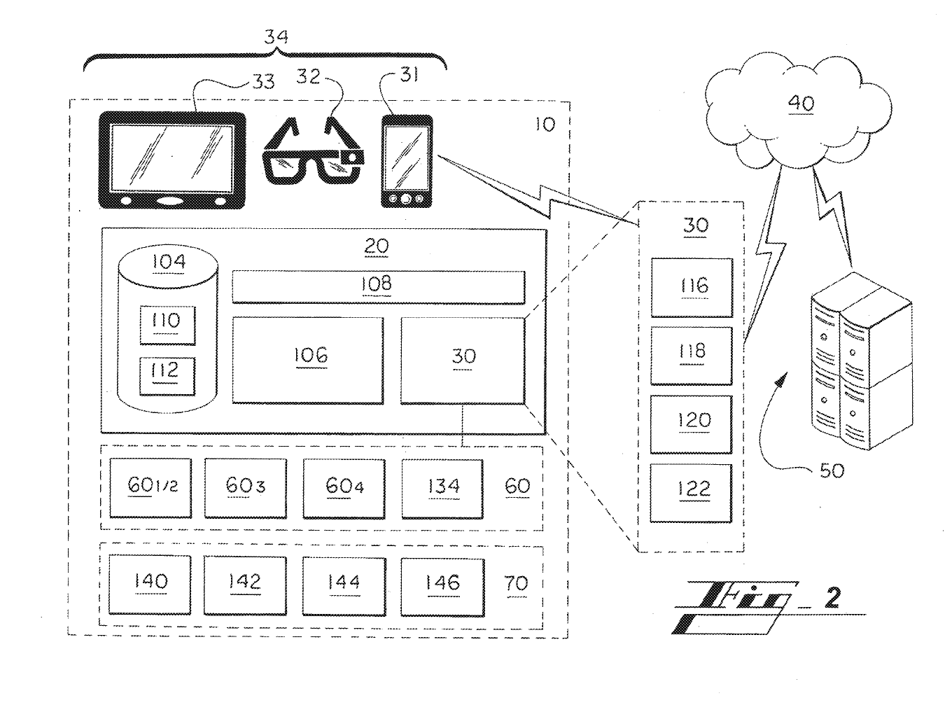

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄. Intra-vehicle-focused sensors 60₁, 60₂, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 60₃, 60₄ sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Portable user devices 34—e.g., user phone, user wearable, or user plug-in device—can be considered as sensors 60 as well, such as in embodiments in which the vehicle 10 uses data provided by the local device based on output of a local-device sensor(s). The vehicle system can use data from a user smartphone, for instance, indicating user-physiological data sensed by a biometric sensor of the phone.

The vehicle 10 also includes cabin output components 70, such as audio speakers 70₁, and an instruments panel or display 70₂. The output components may also include dash or center-stack display screen 70₃, a rear-view-mirror screen 70₄ (for displaying imaging from a vehicle aft/backup camera), and any vehicle visual display device 37.

### III. On-Board Computing Architecture—FIG. 2

FIG. 2 illustrates in more detail the hardware-based computing or controller system 20 of the autonomous vehicle of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as the autonomous vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The data storage device 104 includes one or more storage modules 110 storing computer-readable code or instructions executable by the processing unit 106 to perform the functions of the controller system 20 described herein.

The modules may include any suitable module for perform at the vehicle any of the functions described or inferred herein. For instance, the vehicle modules may include the autonomous-vehicle-service application, an instance of which is also on a portable device of a user that will be guided to a pickup location for the vehicle.

The vehicle modules may also include a vehicle-locating module, which can be considered also illustrated by reference numeral 10. The vehicle-locating module is used to determine the vehicle location, which may be fed to the service application. The system 20 in various embodiments shares the vehicle location data with the service application of the portable device, by direct wireless connection, via an infrastructure network, or via a remote server, for instance.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While portable user devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A portable user device 34, such as a smartphone, can also be remote to the vehicle 10, and in communication with the sub-system 30, such as by way of the Internet or other communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 60₄, such as radar or sonar, directed away from the vehicle, such as for supporting autonomous driving.

Visual-light cameras 60₃ directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 60₃ and the range sensor 60₄ may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 60₄ may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (60₁, 60₂, etc.) configured and arranged (e.g., positioned and fitted in the vehicle) to sense activity, people, cabin environmental conditions, or other features relating to the interior of the vehicle. Example cabin sensors (60₁, 60₂, etc.) include microphones, in-vehicle visual-light cameras, seat-weight sensors, user salinity, retina or other user characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 60₁, 60₂, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing user characteristics include any biometric or physiological sensor, such as a camera used for retina or other eye-feature recognition, facial recognition, or fingerprint recognition, a thermal sensor, a microphone used for voice or other user recognition, other types of user-identifying camera-based systems, a weight sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

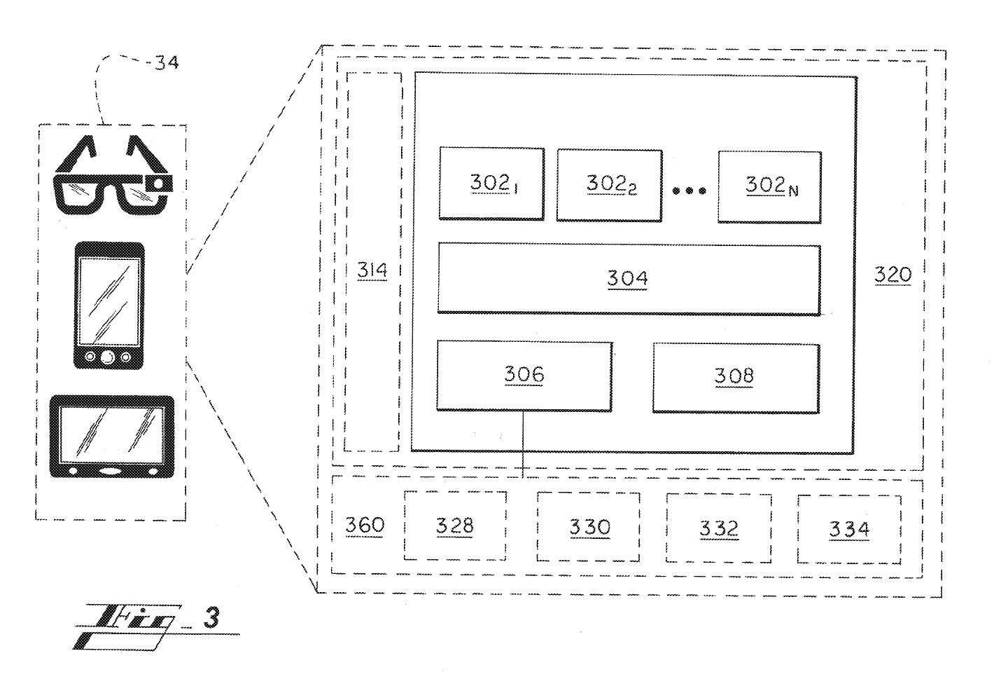

### IV. Example Portable User Device 34—FIG. 3

FIG. 3 illustrates schematically components of an example portable user device 34 of FIGS. 1 and 2, such as smart eyewear, phone, or tablet. The portable user device 34 can be referred to by other terms, such as a local device, a personal device, an ancillary device, system, apparatus, or the like.

The portable user device 34 is configured with any suitable structure for performing the operations described for them. Example structure includes any of the structures described in connection with the vehicle controller system 20. Any portable user component not shown in FIG. 3, or visible in FIG. 3, but described by this relationship to the vehicle controller system 20, is considered shown also by the illustration of the system 20 components in FIGS. 1 and 2.

The portable user device 34 includes, for instance, output components, such as a screen and a speaker.

And the device 34 includes a hardware-based computer-readable storage medium, or data storage device (like the storage device 104 of FIG. 2) and a hardware-based processing unit (like the processing unit 106 of FIG. 2) connected or connectable to the computer-readable storage device of by way of a communication link (like link 108), such as a computer bus or wireless structures.

The data storage device of the portable user device 34 can be in any way like the device 104 described above in connection with FIG. 2.—for example, the data storage device of the portable user device 34 can include one or more storage or code modules storing computer-readable code or instructions executable by the processing unit of the add-on device to perform the functions of the hardware-based controlling apparatus described herein, or the other functions described herein. The data storage device of the add-on device in various embodiments also includes ancillary or supporting components, like those 112 of FIG. 2, such as additional software and/or data supporting performance of the processes of the present disclosure, such as one or more driver profiles or a group of default and/or driver-set preferences. The code modules supporting components are in various embodiments components of, or accessible to, one or more add-on device programs, such as the applications 302 described next.

With reference to FIG. 3, for instance, the example portable user device 34 is shown to include, in addition to any analogous features to those shown in FIG. 1 for the vehicle computing system 20:
applications 302¹, 302², . . . 302^{N};
an operating system, processing unit, and device drivers, indicated collectively for simplicity by reference numeral 304;
an input/output component 306 for communicating with local sensors, peripherals, and apparatus beyond the device computing system 320, and external devices, such as by including one or more short-, medium-, or long-range transceiver configured to communicate by way of any communication protocols—example protocols include Dedicated Short-Range Communications (DSRC), WI-FI®, BLUETOOTH®, infrared, infrared data association (IRDA), near field communications (NFC), the like, or improvements thereof; and
a device-locating component 308, such as one or more of a GPS receiver, components using multilateration, trilateration, or triangulation, or any component suitable for determining a form of device location (coordinates, proximity, or other) or for providing or supporting location-based services.

The portable user device 34 can include respective sensor sub-systems 360. Example sensors are indicated by 328, 330, 332, 334.

In various embodiments, the sensor sub-system 360 includes a user-facing and in some embodiments also a world-facing camera, both being indicated schematically by reference numeral 328, and a microphone 330.

In various embodiments, the sensor include an inertial-momentum unit (IMU) 332, such as one having one or more accelerometers. Using the IMU, the user-portable device 34 can determine its orientation. With location data, the orientation data, and map, navigation, or other database information about the environment that the phone is located in, the user-portable device 34 can determine what the device 34 is facing, such as a particular road, building, lake, etc. These features are important to augmented reality applications, for instance, in which the reality captured by a device camera, for example, is augmented with database information (from the device, a vehicle, a remote server or other source) based on the location and orientation of the device.

With the orientation data, the device 34 can also determine how the user is holding the device, as well as how the user is moving the device, such as to determine gestures or desired device adjustments, such as rotating a view displayed on a device screen.

A fourth symbol 334 is provided in the sensor group 360 to indicate expressly that the group 360 can include one or more of a wide variety of sensors for performing the functions described herein.

Any sensor can include or be in communication with a supporting program, which can be considered illustrated by the sensor icon, or by data structures such as one of the applications 302″. The user-portable device 34 can include any available sub-systems for processing input from sensors. Regarding the cameras 328 and microphone 330, for instance, the user-portable device 34 can process camera and microphone data to perform functions such as voice or facial recognition, retina scanning technology for identification, voice-to-text processing, the like, or other. Similar relationships, between a sensor and a supporting program, component, or structure can exist regarding any of the sensors or programs described herein, including with respect to other systems, such as the vehicle 10, and other devices, such as other user devices 34.

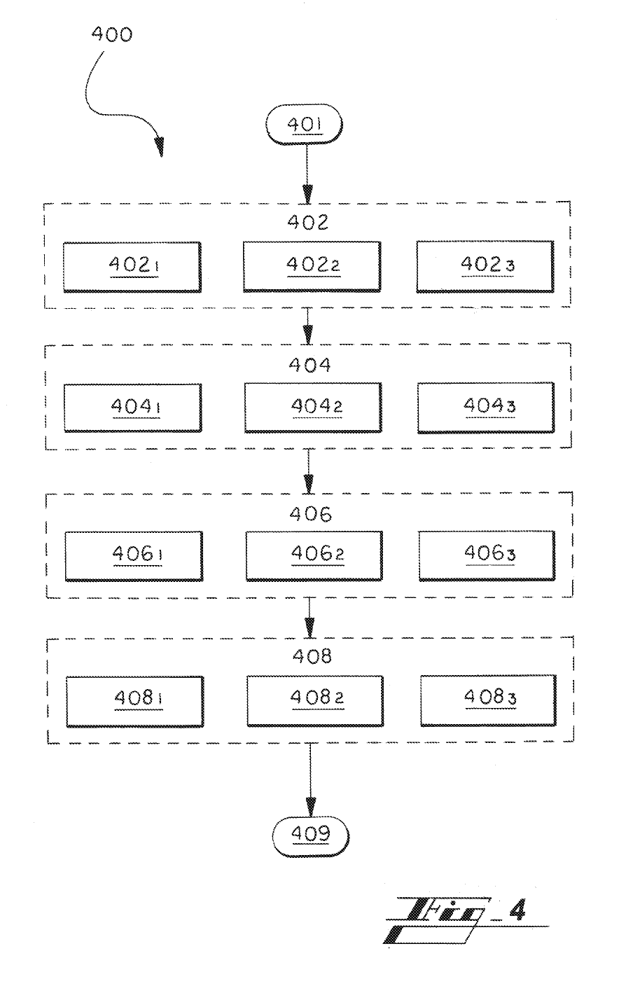

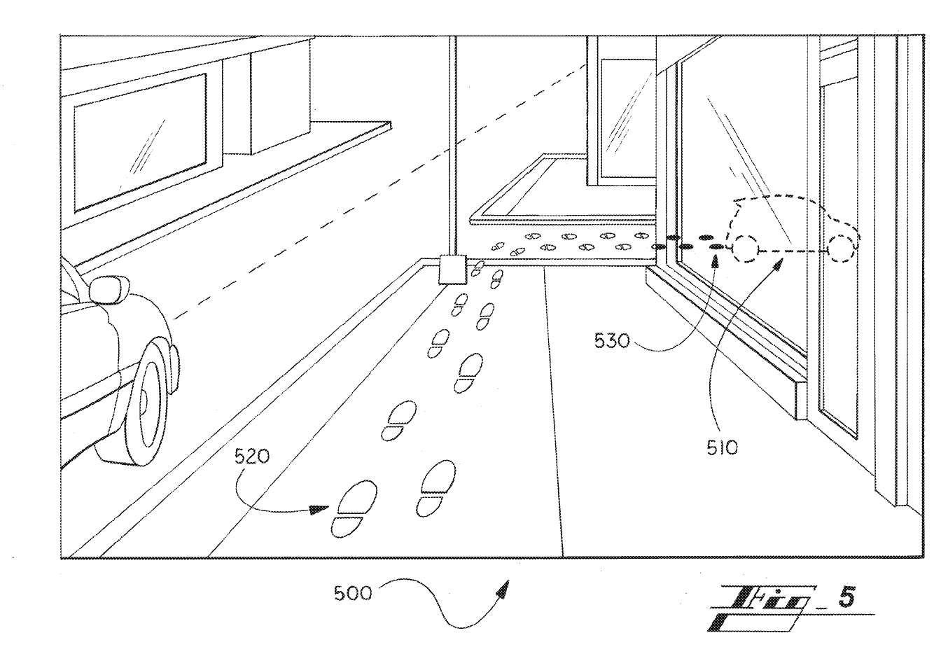

### V. Algorithms and Processes—FIGS. 4 and 5

V.A. Introduction to Processes

FIG. 4 shows an example algorithm as a process flow represented schematically by flow 400 for the user-portable device 34. The flow 400 is at times referred to as processes or methods herein for simplicity.

Though a single process 400 is shown for simplicity, any of the functions or operations can be performed in one or more or processes, routines, or sub-routines of one or more algorithms, by one or more devices or systems.

It should be understood that steps, operations, or functions of the process are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 304 of user-portable device 34 executing computer-executable instructions stored on a non-transitory computer-readable storage device of the respective device, such as the data storage device of the user-portable device 34.

As mentioned, the data storage device of the portable device 34 includes one or more modules for performing the processes of the portable user device 34, and may include ancillary components, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

V.B. System Components and Functions—FIGS. 4 & 5

The process begins 401 and flow continues to block 402 whereat a hardware-based processing unit executes an autonomous-vehicle reservation application to reserve or secure a future ride for the user in the autonomous vehicle 10. As with most functions of the present technology, this function may be performed at any suitable performing system, such as at the portable user device 34 (402₁), another user device (402₂), such as a laptop or desktop computer, and/or at a remote server 50 (402₃).

In various embodiments, the securing involves interacting with the user, such as via a portable device interface (touch screen, for instance). The reservation may also be made by the user at another device, such as a user laptop or desktop computer.

At block 404, an autonomous-vehicle reservation app, executed by a corresponding processing unit, determines, in any of a variety of ways, an autonomous-vehicle pickup location, at which the user will enter the autonomous vehicle 10. As examples, the app may be configured to allow the user to select a pick location, such as any location of a street, loading zone, parking lot, etc., or to select amongst pre-identified pickup locations. In various embodiments, the autonomous-vehicle reservation app determines the pickup location based at least in part on a location of the portable user device 34. Again, the function may be performed at any suitable performing system, such as at the portable user device 34 (404₁), the vehicle 10 (404₂), and/or at a remote server 50 and/or user laptop or desktop computer (404₃).

The pickup-location determination may again be based on any suitable information, such as a present vehicle location, portable user device/user location, surface streets, parking lots, loading zones, etc., near the user or where the user is expected to be around the time of pick up.

At block 406, an augmented-reality walking-directions module, of the portable user device 34 (406₁), the vehicle 10 (406₂), a server 50 (406₃) or other system, executed by corresponding hardware-based processing unit, dynamically generates or obtains walking-direction artifacts for presentation to the user, by the portable user device display, with real-time camera images to show a recommended walking path from the present user location toward the autonomous-vehicle pickup location, yielding real-time augmented-reality walking directions changing as a user moves with the portable user device.

At block 408, an augmented-reality directions-presentation module, of the portable user device 34 (408₁), the vehicle 10 (408₂), and/or a server 50 and/or other system (408₃), executed by corresponding hardware-based processing unit, initiates displaying, by way of a display component of the portable user device 34, the real-time augmented-reality walking directions from the present user location toward the autonomous-vehicle pickup location.

The autonomous-vehicle pickup location, in some implementations, differs from a present autonomous-vehicle location.

The AR artifacts can take any suitable format for directing the user to the pick-up location. Example artifacts include and are not limited to virtual footsteps, virtual lines, virtual arrows, and any of various types of virtual path indicators. Virtual path indicators show visually for the user a path to the pick-up location.

The artifacts include a virtual indication of the autonomous shared or taxi vehicle 10. When an object, such as a building, other vehicles, persons such as a crowd, is between the user-portable device 34 the subject vehicle 10, the virtual vehicle artifact can be displayed in the real-world image at an accurate location, corresponding to the actual location in the display. And the virtual vehicle artifact can in this example be displayed, over or at the object in the image, in a manner, such as by dashed or ghost lining, coloring, or shading, etc. indicating that the actual vehicle 10 is behind the object. The virtual path (e.g., footsteps) can be shown in the same manner or differently at visible and non-visible locations, or in the non-visible locations, such as behind the object that the vehicle is behind, can be shown by dashed, ghost, or other lining, coloring, or shading indicating that the path is behind the object.

FIG. 5 shows an example augmented-reality walking-directions display 500 showing a virtual-vehicle pickup-location artifact 510 and a virtual footsteps path 520 to the virtual-vehicle pickup-location. As mentioned, the path can be shown differently, such as by broken lines when the path goes behind an object—in FIG. 5 the footprint path indicator change color for the steps 530 behind the object being the building at the right in the view of FIG. 5.

In a contemplated embodiment, the virtual vehicle artifact is displayed in a realistic size, based on the location of the user-portable device and the autonomous shared or taxi vehicle 10. The virtual vehicle artifact would thus show smaller when the device 34 if farther from the vehicle 10, and larger as the device 34 gets closer to the vehicle 10, to full, actual, size as the user gets to the vehicle 10.

The walking-direction artifacts may include a first vehicle-indicating artifact positioned dynamically with the camera image to show the present autonomous-vehicle location, and a second vehicle-indicating artifact positioned dynamically with the camera image to show the autonomous-vehicle pickup location.

In various embodiments, the acting system (e.g., processing unit of the portable user device, vehicle, or server) determines that the pickup location and/or the present vehicle location is behind a structure or object, from the perspective of the user/user device. The acting system may configure and arrange the vehicle-indicating artifact(s) with the real-time camera images, to indicate that the present autonomous-vehicle pickup location or the autonomous-vehicle pickup location is behind a structure or object visible in the camera images.

The process 400 can end 413 or any one or more operations of the process can be performed again.

Other aspects of the systems and processes of the present technology are described below.

### VI. Select Summary and Aspects of the Present Technology

Implementing autonomous shared or taxi vehicles, or driverless vehicles, will on many occasions involve getting a user (e.g., customer) together physically with the vehicle for the subsequent autonomous ride to a user destination.

The present technology pairs an autonomous shared or taxi vehicle with the user, such as by the user-portable device 34 and the vehicle 10 communicating, such as to share respective identification or validation information (e.g., reservation code), to share respective location information, to share directions or augmented-reality based instructions, etc.

The present technology pairs an autonomous shared or taxi vehicle 10 with the user, such as by the user-portable device 34 and the vehicle 10 communicating, such as to validate a user as a proper or actually scheduled passenger for a subject ride.

The user-portable device 34 receives pick-up-location data indicating a pick-up zone or location, where the user should meet the autonomous shared or taxi vehicle 10 for pick up. The pick-up-location data indicates a location of the vehicle 10, such as by geo-coordinates. The pick-up-location data can be part of, or used at the user-portable device 34 to generate, augmented-reality based walking (ARW) directions from a user location to the pick-up location. The ARW directions can thus be received by the user-portable device 34 or generated at the device 34 based on supporting information received including location of the autonomous shared or taxi vehicle 10.

The ARW directions, whether generated at the user-portable device 34 or at another apparatus and received by the user-portable device 34, are presented to the user by a visual display, such as a display screen of a user phone, smart watch, or smart eyewear.

Various functions of the present technology are performed in real time, or dynamically. For instance, the ARW directions can be updated in real-time, as any underlying factors change. Example underlying factors include and are not limited to:
1. location of the user (as determined based on location of the user-portable device 34);
2. location of the autonomous shared or taxi vehicle 10;
3. traffic;
4. crowds,
5. road conditions;
6. weather;
7. requests or other needs of other passengers;
8. post-pick-up routing restraints, such as timing needed to reach a waypoint—e.g., another passenger destination before the subject user's destination; and
9. timing considerations—e.g., time of needed pick-up, time of needed subsequent drop off.

The ARW directions, or at least the planned pick-up location, is in some embodiments received at the portable device 34 from the vehicle 10, and indicates for the user where the vehicle 10 will be waiting for the user.

The user-portable device 34, the vehicle 10, and any remote apparatus 50 such as a server can have respective instances of an augmented-reality-walking-directions (ARWD) application configured according to the present technology.

The ARWD application can include or be part of an autonomous-vehicle-reservation (AVR) application, such as by being an augmented-reality extension to such AVR application.

The augmented-reality-walking directions, when presented via the portable device 34 to the user, show a path from a present location of the device 34 to a planned pick-up location. The vehicle 10 may already be at the location, or may be expected to be there by the time the user would arrive at the location.

Presentation of the ARW directions is made a visual display of, or created by, the portable device, such as a device screen or hologram generated by the device 34. The presentation includes real-world imagery received from a world-facing camera of the portable device 34. The presentation further includes virtual, AR artifacts, displayed with the real-world imagery to show the user how to reach the pick-up location.

In various embodiments, the autonomous-vehicle pickup location differs from a present autonomous-vehicle location, and the artifacts presented include both an artifact indicating virtually the pickup location and a virtual vehicle artifact positioned in a the real-world imagery corresponding to an actual present autonomous-vehicle location.

The virtual vehicle artifact is displayed in various embodiments looks in any of various ways like the actual vehicle 10, such as by the same make, model, color, geometry, etc.

The user may appreciate knowing whether there are any people in the vehicles, and whether they are approved passengers. In a contemplated embodiment, with the virtual vehicle artifact are virtual artifacts representing any people associated with the vehicle, such as any other passengers (and a driver if there is one) in or adjacent the vehicle. Data supporting where the people are, and in some cases what they look like, could originate at one or more sensors at the vehicle 10, such as interior and/or external cameras of the vehicle 10. Or known passengers can be shown by icon or avatar, generally in or at the vehicle, or accurately positioned within the virtual vehicle artifact, corresponding to the passengers' positions in the actual vehicle 10.

The virtual display could indicate that each of the people present at the vehicle are appropriate, such as by being scheduled to be riding presently and pre-identified or authorized in connection with their respective arrivals at or entries to the autonomous shared or taxi vehicle 10. The display could provide for each passenger a photo and possibly other identifying information such as demographics (age, gender, etc.).

Similarly, the application at user-portable devices of each passenger already in the vehicle can indicate, by virtual reality or otherwise, that an approved additional passenger is approaching, such as by an avatar or actual moving image of the person as recorded by cameras of the vehicle, of the approaching portable user device 34, and or other camera or sensor, such as nearby infrastructure camera.

The application at the user device 34 in various embodiments receives, from the vehicle 10 or another apparatus (e.g., server 50), or generates, instructions, indicating that the user is to stay at a present user location, move to a location at which the vehicle 10 has not yet arrived. Various locations may be suggested based on any relevant factor, such as traffic, crowds near the vehicle or user, requests or other needs of other passengers, estimated time of pick-up, estimated time of arrive to the subsequent user destination or a waypoint. The vehicle 10 may provide a message or instruction to the portable user device suggesting or advising, for instance, that that user wait a few blocks away from the pre-scheduled pick-up area in order to avoid traffic, etc. The instruction can indicate a rational for the instruction, such as by explaining that traffic is an issue and perhaps explaining the traffic issue. The corresponding VRW directions guide the user to the suggested location.

The technology allows a user to easily reach the taxi and facilitate the taxi also to wait for the user in a place which is most convenient in context of ETA, traffic, etc. For example, the taxi does not need to wait at a location which is at eye sight of the user. It can wait just around the corner; if it helps to avoid traffic and overall reduce the travel time.

In a contemplated embodiment, the user can provide feedback via the portable device 34 that is processed, at the vehicle or a remote apparatus 50, to determine factors such as pick up location and time. The user may provide input indicting that they are running late for instance, or would prefer to walk along another route, such as around the block in a different direction for whatever personal reason they may have. The vehicle 10 or remote apparatus 50 adjusts the meet up plan (pick-up location, timing, etc.) accordingly.

In various embodiments, the system dynamically adjusts the plan as needed based on determined change circumstances, such as if the user walks around the block in a direction other than a route of a present plan, or if the vehicle 10 is kept of schedule by traffic or other circumstance. The change can be made to improve estimated time of pick up or of arrive to a later waypoint or destination, for instance.

The augmented reality application can in such ways pair between the autonomous shared or taxi vehicle 10 and the portable device 34 of the user.

The autonomous shared or taxi vehicle 10 in various embodiments has information about local traffic on or affecting a designated route to pick up the passenger, and also from the pick up to a next waypoint or user destination.

The technology in various embodiments includes an autonomous shared or taxi vehicle 10 notifying the user vis the portable device 34 of a new or updated pick-up area, and the user finding the place where the autonomous taxi is waiting via augmented reality based application on portable device.

The technology in various embodiments provides an efficient manner of communications between the user, via their device 34, and the autonomous vehicle 10, by which the autonomous shared or taxi vehicle 10 can notify the user where it is, or where it will stop and wait for the user, and when. The pick-up location is, as mentioned, not limited to being in areas that are in eyesight of the user.

The solution in various embodiments includes the following at three stages. The following three stages [(A)-(C)] can be implemented as one or more than three stages, and any of the steps can be combined or divided, and other steps can be provided as part of the three stages [(A)-(C)] mentioned or separated from them:
A. Real-time identification, authentication, or verification (generically ‘identification’) of the user by the autonomous shared or taxi vehicle 10:
   i. Using, for example, mobile-device sensor (e.g., device biometric sensor) or input interface (user could type in passcode for instance);
   ii. Or using other sensors or interfaces, such as a vehicle sensor or interface confirming the portable device 34 corresponds to a scheduled pickup, such as by coded signal received from the portable device 34.
   iii. The identification may be performed before ARW directions are provided, such as by being a threshold or trigger required to be met before the directions are provided. Benefits of this function include saving bandwidth and processing requirement at or between one or more participating apparatus (e.g., network usage, phone 34 or vehicle 10 processing, etc.). Another benefit is safety or security, such as of other passengers of the vehicle 10 or of the vehicle, as non-authorized persons are not guided to the vehicle 10.
B. Identification of a best pick-up location, zone, or area, and perhaps time, both of which can as mentioned above be set based on any of a wide variety of factors, modified and updated in real time, also based on any of a wide variety of factors;
   i. The pick-up location can be generated to be the closest location joining the vehicle 10 and mobile-device-holding or wearing user;
   ii. The pick-up location is in some implementations not the closest, but is another location deemed more efficient or convenient for the user or the vehicle for any circumstances, such as crowds, traffic, road conditions, such as construction, the like, or other.
   iii. With or separate from determining the pick-up location, whether at the vehicle 10, portable device 34, and/or other apparatus (e.g., remote server 50), one or more of these apparatus generate the VRW directions to provide to the user via mobile-device virtual reality display.
C. Notification to the user of the pick-up location with respect to the present user location, via the virtual path augmentation generated, leading the user form their location to the autonomous shared or taxi vehicle 10.

### VII. Select Advantages

Many of the benefits and advantages of the present technology are described above. The present section restates some of those and references some others. The benefits described are not exhaustive of the benefits of the present technology.

In the autonomous shared or taxi vehicle scenario, user notification of autonomous shared or taxi vehicle 10 location and timing for pickup is very helpful for the user and the virtual reality directions interface facilities the interaction, and could save the user effort and time and in those and other ways provide added safety for the user.

The technology in operation enhances user satisfaction with use of autonomous shared or taxi vehicles, including increasing comfort with the reservation system and shared or taxi ride, such as by being able to get to the vehicle efficiently, and a feeling of security in knowing before arriving to the vehicle that they are arriving at the proper vehicle and that any other passengers are scheduled and authorized.

A ‘relationship’ between the user(s) and a subject vehicle can be improved—the user will consider the vehicle as more of a trusted tool, assistant, or friend.

The technology can also affect levels of adoption and, related, affect marketing and sales of autonomous-driving-capable vehicles. As users' trust in autonomous-driving systems increases, they are more likely to use one (e.g., autonomous shared or taxi vehicle), to purchase an autonomous-driving-capable vehicle, purchase another one, or recommend, or model use of one to others.

### VIII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, implemented at a portable user device having a display to present augmented-reality walking directions from a present user location to an autonomous-vehicle pickup location, comprising:
a hardware-based processing unit; and
a non-transitory computer-readable storage component comprising:
an augmented-reality walking-directions module that, when executed by the hardware-based processing unit, dynamically generates or obtains walking-direction artifacts for presentation, by a portable user device display, with real-time camera images to show a recommended walking path from the present user location toward the autonomous-vehicle pickup location, yielding real-time augmented-reality walking directions changing as a user moves with the portable user device; and
an augmented-reality directions-presentation module that, when executed by the hardware-based processing unit, initiates displaying the real-time augmented-reality walking directions from the present user location toward the autonomous-vehicle pickup location.

2. The system of claim 1 wherein:
the non-transitory computer-readable storage component comprises an autonomous-vehicle-service application configured to allow the user to reserve an autonomous-vehicle ride, to be met by the user at the autonomous-vehicle pickup location; and
the augmented-reality walking-directions module and the augmented-reality directions-presentation module are part of the autonomous-vehicle-service application.

3. The system of claim 1 further comprising:
the display in communication with the hardware-based processing unit to, in operation of the system, present said real-time augmented-reality walking directions from the present user location toward the autonomous-vehicle pickup location; and
the camera in communication with the hardware-based processing unit to, in operation of the system, generate said real-time camera images.

4. The system of claim 1 wherein the autonomous-vehicle pickup location differs from a present autonomous-vehicle location.

5. The system of claim 4 wherein the walking-direction artifacts comprise:
a first vehicle-indicating artifact positioned dynamically with the camera image to show the present autonomous-vehicle location; and
a second vehicle-indicating artifact positioned dynamically with the camera image to show the autonomous-vehicle pickup location.

6. The system of claim 5 wherein at least one of the first vehicle-indicating artifact or the second vehicle-indicating artifact is configured, and arranged with the real-time camera images, to indicate that the present autonomous-vehicle pickup location or the autonomous-vehicle pickup location is behind a structure or object visible in the camera images.

7. The system of claim 1 wherein the walking-direction artifacts comprise a vehicle-indicating artifact positioned dynamically with the camera image to show the autonomous-vehicle pickup location.

8. The system of claim 1 wherein:
the artifacts include a vehicle-indicating artifact positioned dynamically with the camera image to show the autonomous-vehicle pickup location; and
the vehicle-indicating artifact is configured, and arranged with the real-time camera images, to indicate that the autonomous-vehicle pickup location is behind a structure or object visible in the camera images.

9. The system of claim 8 wherein the walking-direction artifacts indicate a path by footprints.

10. A non-transitory computer-readable storage, for use in presenting, by way of a portable user device, augmented-reality walking directions from a present user location to an autonomous-vehicle pickup location, comprising:
an augmented-reality walking-directions module that, when executed by the hardware-based processing unit, dynamically generates or obtains walking-direction artifacts for presentation, by a portable user device display, with real-time camera images to show a recommended walking path from the present user location toward the autonomous-vehicle pickup location, yielding real-time augmented-reality walking directions changing as a user moves with the portable user device; and
an augmented-reality directions-presentation module that, when executed by the hardware-based processing unit, initiates displaying the real-time augmented-reality walking directions from the present user location toward the autonomous-vehicle pickup location.

11. The system of claim 10 wherein the autonomous-vehicle pickup location differs from a present autonomous-vehicle location.

12. The system of claim 11 wherein the walking-direction artifacts comprise:
a first vehicle-indicating artifact positioned dynamically with the camera image to show the present autonomous-vehicle location; and
a second vehicle-indicating artifact positioned dynamically with the camera image to show the autonomous-vehicle pickup location.

13. The system of claim 12 wherein at least one of the first vehicle-indicating artifact or the second vehicle-indicating artifact is configured, and arranged with the real-time camera images, to indicate that the present autonomous-vehicle pickup location or the autonomous-vehicle pickup location is behind a structure or object visible in the camera images.

14. The system of claim 10 wherein the walking-direction artifacts comprise a vehicle-indicating artifact positioned dynamically with the camera image to show the autonomous-vehicle pickup location.

15. The system of claim 10 wherein:
the artifacts include a vehicle-indicating artifact positioned dynamically with the camera image to show the autonomous-vehicle pickup location; and
the vehicle-indicating artifact is configured, and arranged with the real-time camera images, to indicate that the autonomous-vehicle pickup location is behind a structure or object visible in the camera images.

16. The system of claim 10 wherein the walking-direction artifacts indicate a path by footprints.

17. A process, for presenting, by way of a portable user device, augmented-reality walking directions from a present user location to an autonomous-vehicle pickup location, comprising:
generating or obtaining, dynamically, by a hardware-based processing unit executing an augmented-reality walking-directions module stored at a non-transitory computer-readable storage, walking-direction artifacts for presentation, by a portable user device display, with real-time camera images to show a recommended walking path from the present user location toward the autonomous-vehicle pickup location, yielding real-time augmented-reality walking directions changing as a user moves with the portable user device; and
initiating displaying, by the hardware-based processing unit executing an augmented-reality directions-presentation module stored at the non-transitory computer-readable storage, the real-time augmented-reality walking directions from the present user location toward the autonomous-vehicle pickup location by way of the portable user device.

18. The process of claim 17 wherein the autonomous-vehicle pickup location differs from a present autonomous-vehicle location.

19. The process of claim 17 wherein the walking-direction artifacts comprise:
a first vehicle-indicating artifact positioned dynamically with the camera image to show the present autonomous-vehicle location; and
a second vehicle-indicating artifact positioned dynamically with the camera image to show the autonomous-vehicle pickup location.

20. The process of claim 17 wherein the walking-direction artifacts comprise a vehicle-indicating artifact positioned dynamically with the camera image to show the autonomous-vehicle pickup location.
